(19) United States
(12) Patent Application Publication
(10) Pub. No.: US 2005/0189433 A1
(43) Pub. Date: Sep. 1, 2005

(54) Temperature activated scent wick

(76) Inventor: John R. Burgeson, Andover, MN (US)

Correspondence Address: BRIGGS AND MORGAN P.A., 2200 IDS CENTER, 80 SOUTH 8TH ST, MINNEAPOLIS, MN, 55402, US

(21) Appl. No.: 10/790,271

(22) Filed: Mar. 1, 2004

(51) Int. Cl. A01M 1/00

(52) U.S. Cl. 239/44

(57) ABSTRACT

A Temperature activated scent wick for dispensing into the air above the ground of an animal attraction scent for use by hunters includes a container made of substantially rigid material so as to resist atmospheric pressure affects having an interior volume for holding a volume of scent and substantially equal or greater volume of air. The container is adapted for suspension above the ground. A cap is provided for sealing the container. A temperature buffing scent reservoir passes through the cap with an interior intake end in flow communication with the interior scent volume and an exterior release end. An absorbent scent wick is securable about the temperature buffering scent reservoir release end wherein an increase in ambient temperature associated with morning and afternoon will result in the interior volume of air expanding to force the scent to pass through the temperature buffering scent reservoir on to the wick. A decrease in ambient temperature associated with later day will result in stopping the scent from passing through the reservoir as to conserve the scent.

### BACKGROUND OF THE INVENTION

1. Field of the Invention

The present invention relates generally to devices used in hunting for the release of attractant scents, and more specifically to such devices designed to deposit scent on a wick at a particular location over a period of time without human intervention.

2. Background

The use of animal attractant scents by hunters to increase their chances of hunting success is well known. In particular, these scents can be used in ways that take advantage of the mating processes of certain species. For example, in the case of white-tail deer it is known that the buck will prepare a “scrape” to attract a doe. The scrape is prepared by the buck as he scrapes the ground with his hooves at a particular spot and deposits some urine thereon. This action can serve to attract a doe who will then deposit a particular scent, produced when in heat, on the scrape, thereby indicating her receptiveness for mating. The buck will, in this matter, be alerted to the presence of the doe and will tend to spend more time in the location of his scrape. This increase in time spent in a particular area makes him easier to hunt. Thus, hunters will prepare an artificial scrape, or locate a natural scrape in attempts to attract a buck. This is done by finding a scrape, or preparing a mock scrape by scraping the ground in a manner similar to that of a buck, and then depositing a commercially available scent thereon that signals to the buck the presence of a doe in the correct stage of her estrous cycle.

Devices for depositing such scents on the ground are known, and generally consist of a bottle or other container for holding the scent and a valve for regulating the rate that the scent drips therefrom onto the scrape. Such devices are typically suspended from a branch above the scrape and provide for a continuous release of the scent. However, such a continuous flow is not generally desirable as attractant scents are relatively expensive, and release is not necessary during the night, or during periods of rain when the scent can be washed away. Also, scent on the ground does not disburse as well as scent well above ground such as on a wick.

Other temperature activated scent dispensing devices are known, that operate without the use of a valve mechanism. Examples of such a scent depositing device that could automatically regulate the flow of scent therefrom so as to minimize any waste of the scent and to increase the amount of time that the device could be left unattended are disclosed in U.S. Pat. Nos. 5,220,741; 5,279,062 and 5,361,527.

Hanging scent wicks have also been used that absorb scent manually places thereon and dispense the scent overtime until the wick dries out. Such wicks requires daily scent deposit leaving unwanted human odors around the wick. Examples of these wicks are disclosed in U.S. Pat. Nos. 5,555,663; 6,158,668 and Des. 435,896.

There is a need for a temperature activated scent wick for dispensing scent into the air for use by hunters. Such a wick should dispense during the day and stop at night. The device should contain enough scent as to operate several days without the need for the hunter to approach the device and leave unwanted human odors about the wick.

### SUMMARY OF THE INVENTION

The present invention relates to a scent wick for use by hunters for dispensing scent to attract animals suitable for hunting. A Temperature activated scent wick for dispensing into the air above the ground of an animal attraction scent for use by hunters includes a container made of substantially rigid material so as to resist atmospheric pressure affects having an interior volume for holding a volume of scent and substantially equal or greater volume of air. The container is adapted for suspension above the ground. A cap is provided for sealing the container. A temperature buffing scent reservoir passes through the cap with an interior intake end in flow communication with the interior scent volume and an exterior release end. An absorbent scent wick is securable about the temperature buffering scent reservoir release end wherein an increase in ambient temperature associated with morning and afternoon will result in the interior volume of air expanding to force the scent to pass through the temperature buffering scent reservoir on to the wick. A decrease in ambient temperature associated with later day will result in stopping the scent from passing through the reservoir as to conserve the scent.

The principal object and advantage of the present invention is that it drips scent onto the wick when temperatures are rising and stops dripping if temperatures are not rising. When temperatures fall, the device sucks in air bubbles to replace the scent that has dripped out during the day.

Another object and advantage of the present invention is that the Temperature Activated Scent Wick stops dispensing scent in the evening and throughout the night so it does not waste scent and is less likely to attract deer and other big game animals in the evening and throughout the night when the hunter is not present.

Another object and advantage of the present invention is that the Temperature Activated Scent Wick resumes dripping of scent on the wick in the morning and throughout the day without attendance by the hunter.

Another object and advantage of the present invention is that the scent wick contains enough scent to operate for several days without the need to attend to it or replenish it.

Another object and advantage of the present invention is that the hunter avoids leaving additional human odors in places adjacent to the Temperature Activated Scent Wick which would substantially increase the chance of the hunter being detected by the wild game which also dramatically reduces the hunters chances of success.

### BRIEF DESCRIPTION OF THE DRAWINGS

A more thorough understanding of the operation of the present invention, and of its objects and advantages can be had in light of the following detailed description which refers to the following figures, wherein:

FIG. 1 shows a plan partial cross-sectional view of one embodiment of the present invention.

FIG. 2 shows a plan cross-sectional view broken away of an alternative embodiment

FIG. 3 shows a plan cross-sectional view broken away of a further alternative embodiment.

FIG. 4 shows a plan cross-sectional view of a further alternative embodiment.

FIG. 5 shows a plan cross-sectional view of a further alternative embodiment.

FIG. 6 shows a plan cross-sectional view of further alternative embodiment.

FIG. 7 shows an elevational view of one version of the absorbent scent wick of the invention.

FIG. 8 shows a plan cross-sectional view broken away of a further embodiment.

FIG. 9 shows a perspective view of a further embodiment.

FIG. 10 shows an elevational view of the embodiment of FIG. 9 broken away.

FIG. 11 shows an elevational view of another cap embodiment partially broken away.

FIG. 12 shows an elevational view of the embodiment of FIG. 11.

FIG. 13 shows an elevational view of another cap embodiment partially broken away.

FIG. 14 shows a broken away view of the cap of FIG. 13.

### DETAILED DESCRIPTION OF THE INVENTION

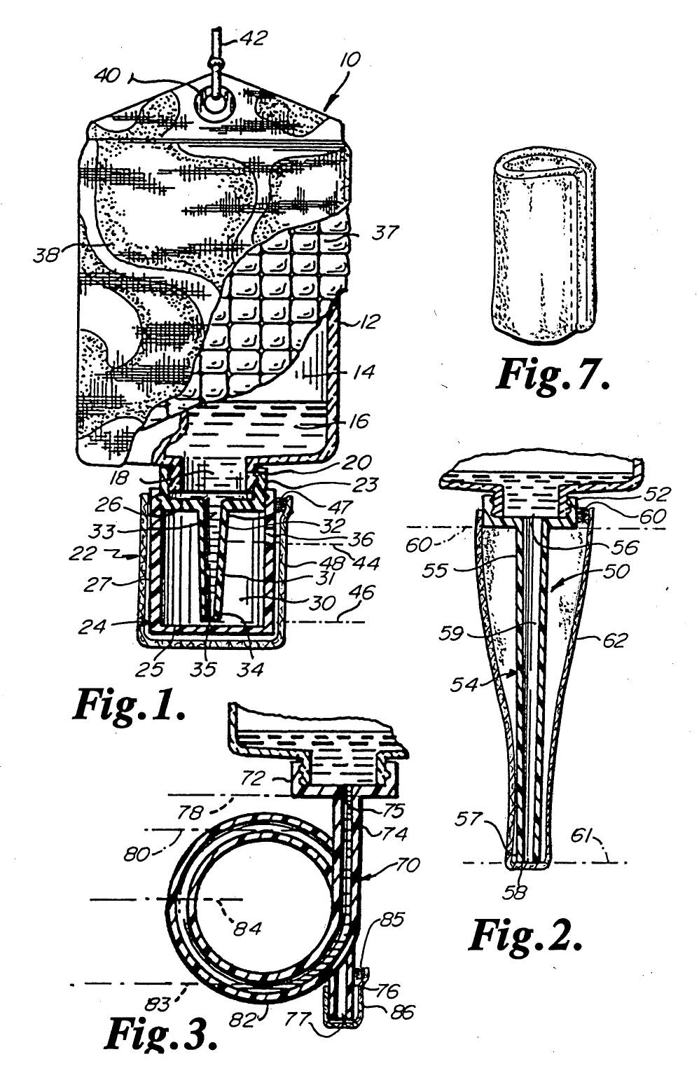

As seen in FIG. 1, the present invention is referred to generally by numeral 10 and includes a substantial rigid container 12 such as a glass or plastic bottle. Container 12 defines an interior volume 14 for holding a liquid scent 16, and has a single opening 18 defined by a neck 20.

A temperature buffering scent reservoir, generally designated 22, includes a cap end portion 23 for providing threadable and sealable engagement with neck 20 of bottle 12. Scent reservoir 22 is preferably made of a plastic material resilient so as to provide for a tight sealing engagement between end portion 23 and bottle 12. Scent reservoir 22 further includes a reservoir portion 24 threadably engageable with cap portion 23, having a base 25, a top end 26 and a sidewall 27 extending therebetween. Base 25, end 26 and sidewall 27 serve to define the rigid exterior housing or surface of the interior volume 30 of reservoir portion 24. A scent delivery conduit 31 having an intake end 32 is integral with top end 26 and defines an intake orifice 33. End 32 extends from the center of top end 26 towards base 25 and terminates with an end 34 having an orifice 35 closely adjacent base 25. Conduit or tube 32 provides for fluid communication of scent 16 between container interior volume 14 and reservoir interior volume 30. A scent releasing orifice 36 extends through sidewall 27 at a point thereon adjacent top end 26. Scent wick 45 essentially covers scent releasing outface 36 and reservoir portion 24 and is releasable held in place by velcro hooks 47.

Scent wick 48 is generally a synthetic felt that will not chemically react with the scent 16. Scent wick 48 will be easily grasped by Velcro hooks 47. The felt must be highly absorbent, so that the scent 16 easily soaks into it and easily wicks out into the air. Various synthetic felts will work, including polyethylene, polypropylene, polyester, nylon, dacron, acrylic or the like.

Bottle 12 may be covered with a thin insulating layer 37, such as a ¼ inch of a foam rubber material, which is in turn covered by a camouflaging material 38. Material 38 includes an eyelet 40 for providing for suspending of the present invention by a string or wire suspension means 42.

The operation of the present embodiment can now be appreciated wherein, reservoir 22 with scent wick 48 is first removed from container 12 so that scent 16 can be poured into interior 14 thereof. After re-engaging reservoir 22 with container 12 scent dispensing device 10 is suspended above the ground whereupon scent is to be distributed. String 42, one end of which is secured to eyelet 40, provides for such suspension from a suitable object such as a tree limb whereby it can be understood that container 12 will be inverted so that reservoir 22 is below container 12 with respect to the ground. Scent 16 will then flow to and stop at end 32 of tube 31. This stoppage of flow is due primarily to the fact that interior volume 14 is sealed to prevent air from leaking into that interior volume and thereby allowing scent to be released.

It can now be appreciated that an increase in temperature will cause expansion of the air in container 12 resulting in scent 16 being forced into reservoir volume 30 through conduit 31. If the temperature increase is great enough scent 16 will fill reservoir volume 30 up to an above the level of orifice 36, such level being indicated by dashed line 44. Scent 16 can then exit through orifice 36 onto the scent wick 48. Conversely, when the temperature cools in the evening, the air in container 12 will contract whereby scent 16 will be drawn out of reservoir volume 30 down to the level as indicated by dashed line 46. When volume 30 is lowered to level 46, air can then be sucked up tube 31 and into interior volume 14 of container 12. This added volume of air replaces the volume of scent 16 deposited and allows additional scent 16 to be released during the next heating cycle. It can be seen that container 12 must be rigid so as to resist any atmospheric pressure effects that can tend to distort the interior volume thereof and thereby detract from the proper operation of the present invention.

The present invention, thus, takes advantage of the relative change in temperature that generally occurs between day and night. It can also be appreciated that, after the first cycle of scent deposition onto wick 48, the size of the interior reservoir volume that must first be filled, before scent deposition can take place, is indicated by the volume thereof between dashed lines 44 and 46. This size therefore affects what degree of temperature increase, given a particular initial ratio of scent volume to container interior volume, is necessary to first cause such scent release. The minimum degree change desired for initial scent deposition can vary with respect to regional hunting conditions and requirements. However, it has been found that for conditions as typically encountered in the northern United States, a 10 degree Fahrenheit increase requirement is desirable to provide for adequate scent release buffering for this embodiment. Given a container volume of approximately 150 ml, and a ratio of the volume of scent to the interior volume of the container of about 1 to 4, a temperature increase of 10 degrees Fahrenheit will result in approximately 2.5 ml of scent being expelled from the container into the reservoir. Thus, the reservoir volume would have to equal approximately 2.5 ml to provide for the desired buffering effect. Generally speaking, about 2 to 5 mls of scent should be deposited each day to refresh scent wick 48 used to hunt white-tailed deer. Such volume of scent release will be accomplished in the above example if the daily increase in temperature is from 15 to 20 degrees Fahrenheit. Thus, the present invention can provide for unattended scent release, under average conditions as experienced by hunters in the northern United States, during a period from 5 to 9 days. As reservoir portion 24 is threadably engagable with cap portion 23, it is contemplated that reservoirs of differing sizes can be used to accommodate various buffering volumes as may be dictated by particular hunting conditions.

It can be appreciated that, the ratio between the volume of scent and the volume of the container affects the amount of scent pushed from the container, whereby the larger the proportion of air within the container is to the volume of scent initially, the greater will be the amount of scent so released for a given temperature increase. The above stated 1 to 4 ratio allows for an adequate amount of air in the container to push out the desired amount of scent under the above described conditions and parameters. However, it will be appreciated by those of skill, that changes of the ratio of the volume of scent to the interior volume of the container, and changes of the reservoir volume can be made to adapt the invention herein to differing hunting or climatic conditions or requirements. Thus, if greater temperature buffering is desired the reservoir volume could be increased and/or the volume of scent initially placed into the container could be increased with respect to the volume thereof, and conversely, if less temperature buffering is needed.

A further embodiment of the present invention is seen in FIG. 2, wherein the modification is represented by a temperature buffering scent reservoir generally designated 50. Reservoir 50 includes a cap end 52 for providing sealable and releasable engagement with container 12. Reservoir 50 also includes a tube portion 54 sealably attached to or integral with cap end 52. Portion 54 includes an intake end 55 defining an intake orifice 56 and extending therefrom to a release end 57 defining a scent release orifice 58. A temperature buffering volume 59 is defined as that portion of the interior volume of tube 54 extending between dashed lines 60 and 61. Velcro hooks 62 hold scent wick 63 releasably in place.

In operation, as with the previous embodiment, after adding scent 16 to container 12, the present invention is suspended above the ground whereby scent dispensing reservoir 50 depends below container 12. Scent 16 will initially start at a level represented by dashed line 60. Thus, an increase in temperature will cause scent 16 to travel through orifice 56 down tube 54 towards orifice end 57. If the increase is sufficient scent can then be expelled out of orifice 58 for deposition onto scent wick 63. Reduction of temperature will cause scent 16 to be pulled back into container 12 as the air therein contracts ultimately resulting in more air being sucked therein when scent 16 reaches level 60.

Tube portion 54 can be made of a flexible plastic material. Also, it is desirable that the inside diameter thereof be on the order of approximately ⅛th of an inch to help insure that the surface tension of the scent is sufficient to prevent air from bubbling up into container 12 as the result of the present invention being moved or shaken by the wind or other forces.

A further embodiment of the present invention is seen in FIG. 3, wherein the modification is represented by a temperature buffering scent reservoir generally designated 70. Reservoir 70 includes an attachment or cap portion 72 for providing sealable and releasable engagement with container 12. Reservoir 70 also includes a tube reservoir portion 73 having an intake end 74 defining an intake orifice 75. End 74 is secured to, or integral with cap portion 72 and extends therefrom to a scent releasing end 76 defining a scent release orifice 77, about which is scent wick 86 held in place by velcro hooks 85. In contradistinction to the embodiment seen in FIG. 2, tube portion 74 is formed into a loop whereby it extends through an arc of 360 degrees.

In operation, as with the other described embodiments, after adding scent 16 to container 12, the present invention is suspended above the ground whereby scent dispensing reservoir 70 depends below container 12. Scent 16 will initially start at a level represented by dashed line 78. Thus, an increase in temperature will cause scent 16 to travel through orifice 75 into tube portion 73 towards end 76. If the temperature increase is sufficient, scent can travel to the apex of the circular loop portion as indicated by dashed line 80 tangent thereto. It can be understood that scent 16 will then be able to flow down the remaining length of tube portion 73 and out of orifice 77 for ultimate deposition onto the scent wick 86. Tube portion 73 can be made of a flexible plastic material. Also, the inside diameter thereof can be somewhat greater than that of tube 54 of the embodiment in FIG. 2, as the formation of tube into a loop serves to further resist the accidental release of scent therefrom, as opposed to the FIG. 2 embodiment. This is due to the fact that once scent has been deposited and the cooling or contraction cycle has begun air will be sucked into container 12 whereby scent 16 will be drawn to the level indicated by dashed line 83. At this level air can be sucked into container 12 and, as a result thereof, scent 16 will not be drawn further into tube 73 in the direction of container 12. Therefore, a portion of scent 16 will always reside above the bottom most point 82 of tube 73. Thus, air must oppose gravity to enter into container 12 once scent 16 is pulled beck to the level indicated by line 83. It can now be appreciated that the buffering volume of tube 73 between the levels indicated by dashed lines 80 and 83. The inside diameter of tube portion 73 can be on the order of approximately ¼th of an inch, and to achieve the desired buffering and volume of scent deposition under conditions as experienced in the northern United States, should be approximately 7 inches long. It can be appreciated that tube portion 73 need not travel through a full 360 degrees of arc to be effective to resist air entering into container 12, as for example tube portion 73 could, if suitable changes were made to the length and, or interior volume thereof, be formed into a j-shape by being cut off at the level as indicated by dashed line 84.

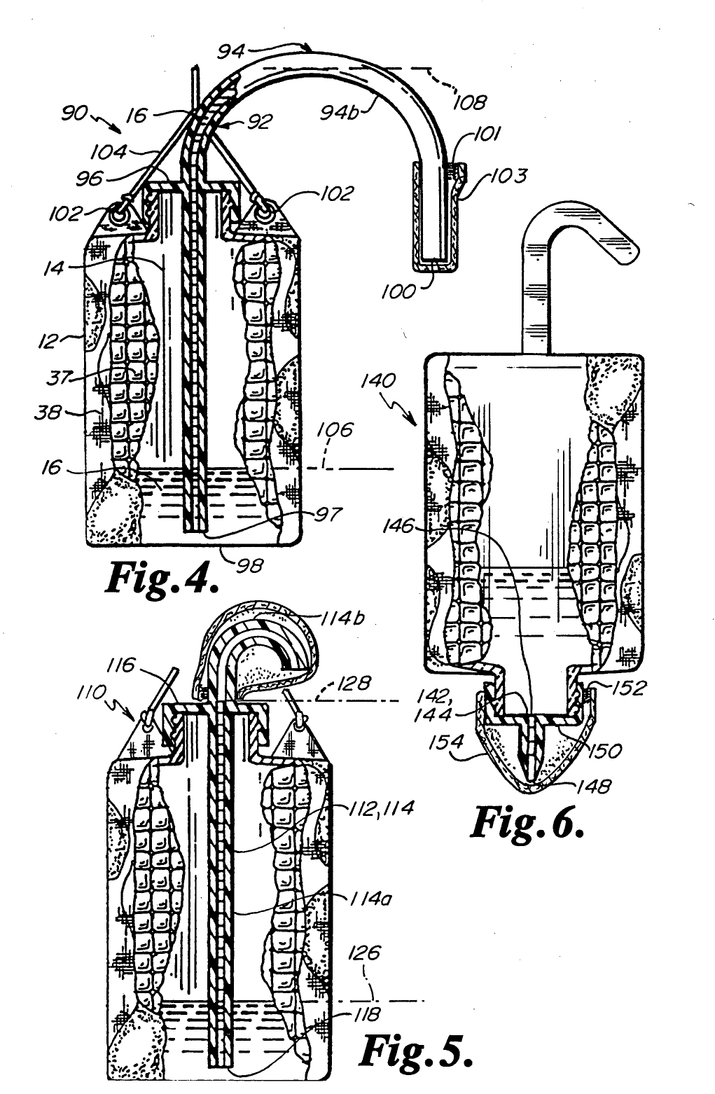

A further embodiment of the present invention is seen in FIG. 4, and generally designated 90. Embodiment 90 is designed to be suspended in a manner inverse to that of the previously described embodiments wherein the temperature buffering scent reservoir 92 is held above container 12 with respect to the ground. Reservoir 92 includes tube reservoir portion 94 and a cap portion 96. Cap 96 is sealably and releasably secured to container 12. Tube portion 94 extends through cap 96 and is sealably engaged or integral therewith. Interior tube section 94a of tube portion 94 extends into the interior volume 14 of container 12 and terminates therein with a scent intake orifice 97 closely adjacent the bottom end 98 of container 12. Exterior tube section 94b extends exterior of container 12 and terminates with a scent release orifice 100, about which is secured scent wick 103 secured thereat with Velcro hooks 101.

Embodiment 90 also includes a pair of eyelets 102 and string or wire suspension means 104, for providing suspension thereof above the ground.

In operation, scent 16 is added into container 12, reservoir 92 is sealably engaged with container 12, after which dispenser 90 is suspended above the ground by suspension means 104. As opposed to the previously described embodiments, temperature buffering reservoir 92 will, with the exception of interior tube section 94a, be oriented above container 12 with respect to the ground. Initially scent 16 will be at the level within tube section 94a as indicated by dashed line 106. Dispenser 90 operates in the same manner as described herein with the previous embodiments of the present invention. Specifically, an increase in temperature will cause an expansion of the air within volume 14 resulting in scent 16 being pushed into orifice 97, through tube portion 94 and ultimately out of orifice 100, to drip onto the scent wick 103. Interior tube section 94a is needed to reach scent 16, which due to the orientation of this embodiment, will reside at the bottom 98 of container 12. As with the other embodiments, a decrease in temperature will contract the air in container 12 causing scent 16 to be pulled back therein, and can result in additional air being brought into container 12 to replace the volume of scent 16 dispensed. In operation scent 16 will flow out of tube 94 when it reaches the apex or high point of the arcuate exterior portion 94a, as is indicated by the dashed line 108 tangent to that apical point. Thus, for the first cycling it can be seen that the reservoir buffering volume is represented by the volume of tube portion 94 between dashed lines 106 and 108. However after the first deposition of scent and contraction, the exterior air drawn in will be held at the level of orifice 97. Therefore, the effective reservoir volume for subsequent depositions will be the interior volume of tube 94 between orifice 97 and level 108. Furthermore, tube portion 94 is j-shaped whereby orifice 100 is held somewhat away from bottle 12 so that scent 16 can be cleanly dispensed onto the wick 103 without contacting container 12.

A further embodiment of the present invention is seen in FIG. 5, and generally designated 110. Embodiment 110 is also designed to be suspended in a manner inverse to that of the previously described embodiments wherein the temperature buffering scent reservoir 112 is held above the container 12 with respect to the ground. Reservoir 112 includes tube reservoir portion 114 and a cap portion 116. Cap 116 is sealable and releasably secured to container 12. Tube portion 114 extends through cap 116 and is sealably engaged or integral therewith. Interior tube section 114a of a tube portion 114 extends into the interior volume 14 of container 12 and terminated therein with a scent intake orifice 118 closely adjacent the bottom end 98 of container 12. Exterior tube section 114b extends exterior of container 12 and terminates with a scent release orifice 120, about which is secured scent wick with Velcro hooks 122. The operation of this embodiment 110 dictates the reservoir buffering volume to be represented by the volume of the tube portion 114 between dashed lines 126 and 128.

A further embodiment of the present invention is seen in FIG. 6, wherein the modification is represented by a temperature buffering scent reservoir generally designated 142. Reservoir 142 includes a cap end 150 for providing sealable and releasable engagement with container 12. Reservoir 142 also includes a tube portion 144 sealably attached to or integral with cap end 150. Portion 144 includes an intake end 146 (flush with cap 150) extending therefrom to a release end 148. Velcro hooks 152 hold scent wick 154 releasably in place. FIG. 7 shows one possible embodiment of a scent wick.

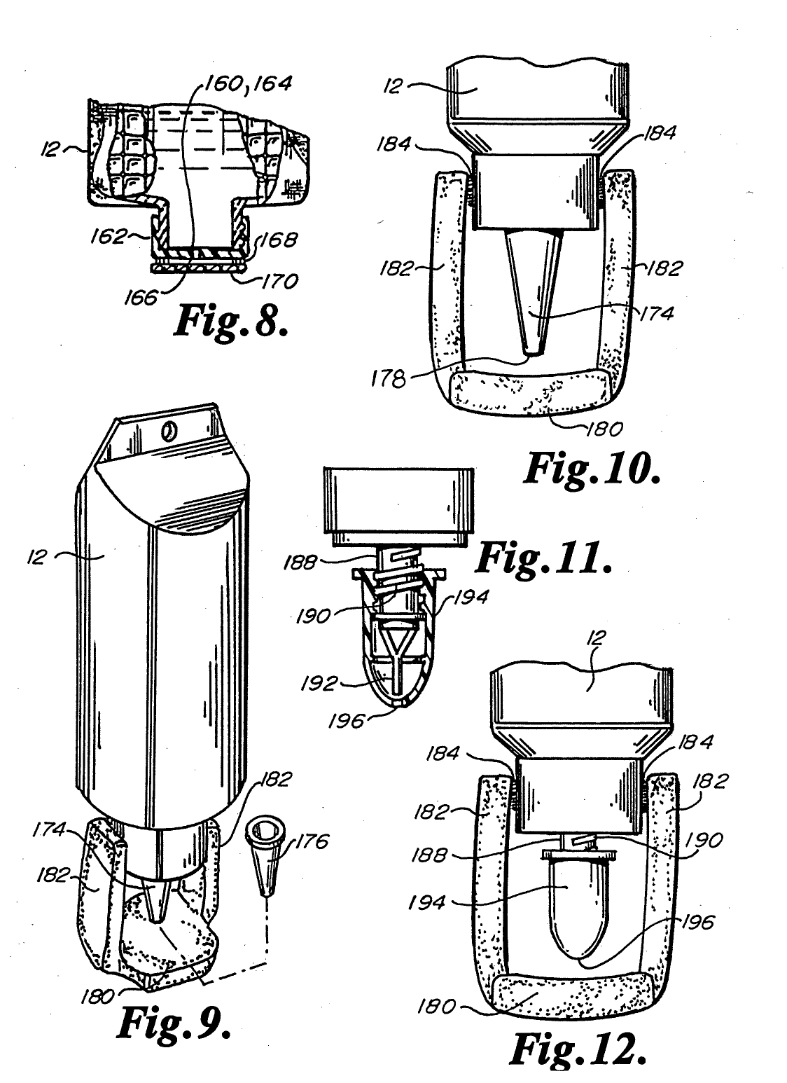

Another further embodiment of the present invention is seen in FIG. 8, wherein the modification is represented by a temperature buffering scent reservoir or pin hole 160 through cap 162. Cap 162 provides sealable and releasable engagement with container 12. Scent reservoir 160 holds the scent therein by surface tension. Reservoir includes an intake end 164 and a release end 166. Velcro hooks 168 hold scent wick 170 releasably in place. As the air inside container 12 expands, the resistive surface tension action is overcome and the scent is forced out release end 166 onto scent wick 170. The process is reversed as the day ends.

Yet another embodiment of the present invention is seen in FIGS. 9 and 10. The temperature buffering scent reservoir is designated 174. Reservoir 174 is similar to a cap of a plastic ketchup or honey bottle and interiorly looks like reservoir 142 of FIG. 6. A closure 176 is available to seal the container 12 and reservoir 142. Scent wick 180 is suspended below, but not touching, external reservoir tip 178. Otherwise, wick 180 might necessarily draw out scent from container 12. Scent wick 180 has opposing wings 182 for support and attachment to reservoir by Velcro hooks 184.

Another embodiment of the present invention is seen in FIGS. 11 and 12. The temperature buffering scent reservoir is designated 188. Reservoir 188 resembles a cap to a glue bottle made of plastic. Reservoir 188 is exteriorly threaded 190 and supports a depending plug 192. A closure 194 is interiorly threaded and secured onto reservoir 188. Closure 194 has a small aperture 196 aligned with plug 192. With closure 194 screwed outwardly, scent may be forced our to drip onto wick 180 with support wings 182 held in place by Velcro hooks 184.

Reservoirs 142, 160, 174, 188 and 200 of FIG. 6 and 8 through 14 hold the scent within container 12 by surface tension due to their smaller release ends 148, 160, 196 and 206 and reservoir volumes. Hence these reservoirs do not require as great as a daily temperature variation as the reservoirs 22, 50, 70, 92 and 112 of FIGS. 1 through 5.

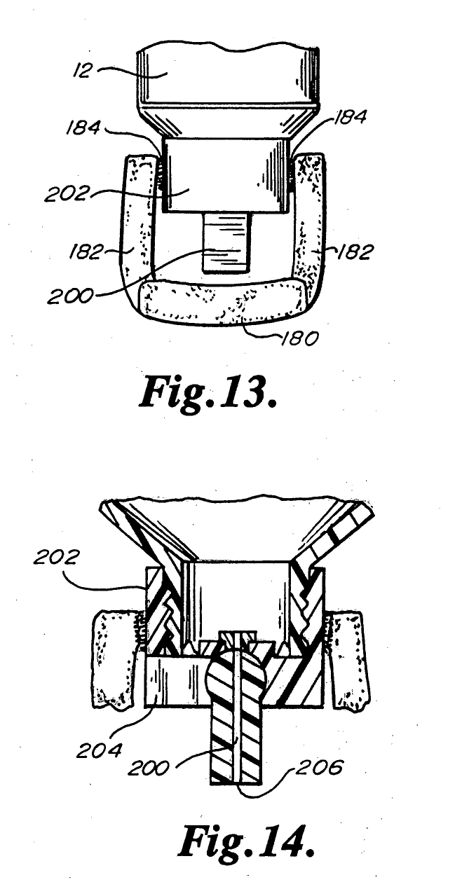

A final embodiment is shown in FIGS. 13 and 14. The temperature buffering scent reservoir is designated 200. Reservoir 200 resembles a cap to a squeeze bottle made of plastic. Reservoir 200 is rotatably captured in cap 202. Reservoir 200 is in flow communication with container's 12 interior 14 when rotated outwardly from its closed and stored position from recess 204. Scent may be forced out release end 206 to drip onto wick 180 with support wings 182 held in place by Velcro hooks 184.

It will be appreciated by those of skill in the art that a wide variety of modifications to the present invention with respect to, for example, reservoir and container shapes and dimensions, and with respect to the orientation thereof to each other and to the ground, can be made without departing from the spirit or scope of the essential attributes thereof. Therefore, it is desired that the disclosed embodiments be considered in all respects as illustrative and not restrictive, reference being made to the appended claims rather to the foregoing description to indicate the scope of the invention.

1. A temperature activated scent wick for dispersion into the air above the ground of an animal attractant scent for use by hunters to take advantage of the mating process of certain species to be hunted, such as white tail deer, the wick comprising:
a) a container made of substantially rigid material so as to resist atmospheric pressure affects having an interior volume for holding a volume of scent and a volume of air, the container adapted for suspension above the ground;
b) a cap for sealing the container;
c) a temperature buffering scent reservoir passing through the cap with an interior intake end in flow communication with the interior scent volume and an exterior release end; and
d) an absorbent scent wick securable about the temperature buffering scent reservoir exterior release end wherein an increase in ambient temperature associated with morning and afternoon will result in the interior volume of air expanding to force the scent to pass through the temperature buffering scent reservoir on to the wick and a decrease in ambient temperature associated with later day will result in stopping the scent from passing through the reservoir as to conserve the scent.

2. The wick of claim 1, wherein the wick does not touch the exterior release end.

3. The wick of claim 1, wherein the reservoir comprising a tube with the interior intake end inside the cap and the exterior release end outside the cap with a reservoir housing with an aperture therethrough securable to the cap about the exterior release end and the scent wick securable to the reservoir housing above the aperture.

4. The wick of claim 1, wherein the reservoir comprises a tube of small diameter as to hold the scent within the reservoir with surface tension.

5. The wick of claim 1, wherein the reservoir comprises a tube with up and down angles as to hold the scent within the reservoir.

6. The wick of claim 1, wherein the reservoir comprises a tube extending toward the bottom of the container and up through the cap.

7. The wick of claim 1, further comprising a closure for the exterior release end of the reservoir.

8. A temperature activated scent wick for dispersion into the air above the ground of an animal attractant scent for use by hunters to take advantage of the mating process of certain species to be hunted, such as white tail deer, the wick comprising:
a) a container made of substantially rigid material so as to resist atmospheric pressure affects having an interior volume for holding a volume of scent and a substantially equal or greater volume of air, the container adapted for suspension above the ground with a downwardly directed opening;
b) a cap for sealing the opening of the container;
c) a temperature buffering scent reservoir passing through the cap with an interior intake end in flow communication with the interior scent volume and an exterior release end; and
d) an absorbent scent wick securable about but apart from the exterior release end wherein an increase in ambient temperature associated with morning and afternoon will result in the interior volume of air expanding to force the scent to pass through the temperature buffering scent reservoir out through the reservoir exterior release end onto the wick, and a decrease in ambient temperature associated with later day will result in stopping the scent from passing through the reservoir release end as to conserve the scent.

9. The wick of claim 7, wherein the reservoir comprises a tube of small diameter as to hold the scent within the reservoir with surface tension.

10 The wick of claim 7, wherein the decrease in ambient temperature will draw the scent from the tube and housing with air back into the container.

11. A temperature activated scent wick for dispersion into the air above the ground of an animal attractant scent for use by hunters to take advantage of the mating process of certain species to be hunted, such as white tail deer, the wick comprising:
a) a container adapted to be suspendable above the ground from a tree made of substantially rigid material so as to resist atmospheric pressure affects having an interior volume for holding a volume of scent and a substantially equal or greater volume of air, the container adapted for suspension above the ground;
b) a cap for sealing the container;
c) a temperature buffering scent reservoir comprising a tube of small diameter passing through the cap with an interior intake end in flow communication with the interior scent volume and an exterior release end; and
d) an absorbent scent wick securable about the temperature buffering scent reservoir exterior release end wherein an increase in ambient temperature associated with morning and afternoon will result in the interior volume of air expanding to force the scent to pass through the temperature buffering scent reservoir on to the wick and a decrease in ambient temperature associated with later day will result in stopping the scent from passing out through the reservoir as to conserve the scent but rather will draw the scent from the tube with air bubbles into the container.

12. The wick of claim 11, wherein the tube has up and down angles as to hold the scent within the reservoir

13. The wick of claim 11, wherein the tube extends toward the bottom of the container and up through the cap.

14. A temperature activated scent wick for dispersion into the air above the ground of an animal attractant scent for use by hunters to take advantage of the mating process of certain species to be hunted, such as white tail deer, the wick comprising:
a) a container made of substantially rigid material so as to resist atmospheric pressure affects having an interior volume for holding a volume of scent and substantially equal or greater volume of air, the container adapted for suspension above the ground;
b) a cap for sealing the container;
c) a temperature buffering scent reservoir comprises a rube passing through the cap with an interior intake end in flow communication with the interior scent volume and an exterior release end with up and down angles; and
d) an absorbent scent wick securable to the cap, about and apart from the temperature buffering scent reservoir exterior release end wherein an increase in ambient temperature associated with morning and afternoon will result in the interior volume of air expanding to force the scent to pass through the temperature buffering scent reservoir on to the wick and a decrease in ambient temperature associated with later day will result in stopping the scent from passing through the reservoir as to conserve the scent.

15. The wick of claim 14, wherein the container is adapted to be suspendable above the ground from a tree.

16. The wick of claim 11, wherein the tube extends toward the bottom of the container and up through the cap
